(19) United States
(12) Patent Application Publication
(10) Pub. No.: US 2022/0391762 A1
(43) Pub. Date: Dec. 8, 2022

(54) DATA GENERATION DEVICE, DATA GENERATION METHOD, AND PROGRAM RECORDING MEDIUM

(71) Applicant: NEC Corporation, Minato-ku, Tokyo (JP)

(72) Inventor: Hiroyuki TOKUCHI, Tokyo (JP)

(73) Assignee: NEC Corporation, Minato-ku, Tokyo (JP)

(21) Appl. No.: 17/786,209

(22) PCT Filed: Dec. 26, 2019
(86) PCT No.: PCT/JP2019/051272

§ 371 Date: Jun. 16, 2022

(51) Int. Cl. G06N 20/00

(52) U.S. Cl. CPC G06N 20/00

(57) ABSTRACT

A data generation device includes a detection unit and a generation unit. The detection unit is configured to detects, from the first training data, a characteristic portion that contributes to the classification into the prescribed categories when first training data is to be classified into prescribed categories by a trained analytical model. The generation unit is configured to generate second training data by processing the first training data in a way that corresponds to the characteristic portion.

### TECHNICAL FIELD

The present invention relates to a data generation device or the like that augments training data to be used for machine learning.

### BACKGROUND ART

In machine learning, particularly supervised learning, an analytical model exhibiting high generalization performance can be constructed using a large amount of training data. However, it is difficult to construct the analytical model exhibiting high generalization performance unless a sufficient number of pieces of training data can be prepared. From such a background, techniques for increasing training data in a pseudo manner (hereinafter, referred to as data augmentation) has been proposed.

PTL 1 discloses a system that automatically generates training data for machine learning. The machine learning system of PTL 1 generates a pseudo label image from a random number value vector, and generates an image, analogized from the pseudo label image according to a conversion characteristic from an original label image to an original sample image as a pseudo sample image related to the pseudo label image.

### CITATION LIST

### Patent Literature

[PTL 1] JP 2019-046269 A

### Non Patent Literature

[NPL 1] R. Selvaraju, et al., “Grad-CAM: Visual Explanations from Deep Networks via Gradient-based Localization”, arXiv:1610.02391v3 [cs.CV] 21 Mar. 2017.
[NPL 2] D. Smilkov, et al., “SmoothGrad: removing noise by adding noise”, arXiv:1706.03825v1 [cs.LG] 12 Jun. 2017.
[NPL 3] F. Wang, et al., “Residual Attention Network for Image Classification”, arXiv:1704.06904v1 [cs.CV] 23 Apr. 2017.
[NPL 4] J. Hu, et al., “Squeeze-and-Excitation Networks”, arXiv: 1709.01507v4 [cs.CV] 16 May 2019.

### SUMMARY OF INVENTION

### Technical Problem

In the technique of PTL 1, the pseudo sample image related to the pseudo label image generated from the random number value vector is generated. That is, the pseudo sample image is randomly processed data. In general, in a case where randomly processed data is generated as training data, there is a high possibility that inconvenient training data that should not be trained is generated, and thus, there is a problem of a decrease in generalization performance indicating performance of classifying training data into correct categories by an analytical model.

An object of the present invention is to provide a data generation device or the like capable of generating training data that enables generation of an analytical model exhibiting high generalization performance.

### Solution to Problem

A data generation device according to one aspect of the present invention is provided with: a detection unit that, when first training data is classified into a prescribed category by a trained analytical model, detects, from the first training data, a characteristic portion that contributes to the classification into the prescribed category; and a generation unit that generates second training data by processing the first training data in relation to the characteristic portion.

In a data generation method according to one aspect of the present invention, a computer detects a characteristic portion that contributes to classification into a prescribed category from first training data when the first training data is classified into the prescribed category by a trained analytical model, and generates second training data by processing the first training data in relation to the characteristic portion.

A program according to an aspect of the present invention causes a computer to execute: a process of detecting a characteristic portion that contributes to classification into a prescribed category from first training data when the first training data is classified into the prescribed category by a trained analytical model; and a process of generating second training data by processing the first training data in relation to the characteristic portion.

### Advantageous Effects of Invention

According to the present invention, it is possible to provide the data generation device or the like capable of generating the training data that enables the generation of the analytical model exhibiting high generalization performance.

### BRIEF DESCRIPTION OF DRAWINGS

FIG. 1 is a block diagram illustrating an example of a configuration of a learning system according to a first example embodiment of the present invention.

FIG. 2 is a flowchart for describing an example of data generation processing by a data generation device of the learning system according to the first example embodiment of the present invention.

FIG. 3 is a block diagram illustrating an example of a configuration of a learning system according to a second example embodiment of the present invention.

FIG. 4 is a block diagram illustrating another example of the configuration of the learning system according to the second example embodiment of the present invention.

FIG. 5 is a block diagram illustrating an example of augmented training data generated by a generation unit provided in a data generation device of the learning system according to the second example embodiment of the present invention.

FIG. 6 is a block diagram illustrating an example of the augmented training data generated by the generation unit provided in the data generation device of the learning system according to the second example embodiment of the present invention.

FIG. 7 is a block diagram illustrating an example of the augmented training data generated by the generation unit provided in the data generation device of the learning system according to the second example embodiment of the present invention.

FIG. 8 is a block diagram illustrating an example of the augmented training data generated by the generation unit provided in the data generation device of the learning system according to the second example embodiment of the present invention.

FIG. 9 is a block diagram illustrating an example of the augmented training data generated by the generation unit provided in the data generation device of the learning system according to the second example embodiment of the present invention.

FIG. 10 is a block diagram illustrating an example of the augmented training data generated by the generation unit provided in the data generation device of the learning system according to the second example embodiment of the present invention.

FIG. 11 is a block diagram illustrating an example of a configuration of a data generation device according to a third example embodiment of the present invention.

FIG. 12 is a block diagram illustrating an example of a hardware configuration for implementing the learning systems according to the example embodiments of the present invention.

### EXAMPLE EMBODIMENT

Hereinafter, modes for carrying out the present invention will be described with reference to the drawings. In all the drawings used in the following description of the example embodiments, similar parts are denoted by the same reference signs unless there is a particular reason. In the following example embodiments, repeated descriptions regarding similar configurations and operations are sometimes omitted.

### First Example Embodiment

First, a learning system according to a first example embodiment of the present invention will be described with reference to the drawings. The learning system of the present example embodiment increases the number of pieces of training data as a learning target by using training data to be used for machine learning (hereinafter, also referred to as learning). The training data is a data set including data and a category associated with the data. In the technical field of the machine learning, a category is also referred to as a label. Hereinafter, increasing the number of pieces of training data is expressed as augmenting the training data. The learning system according to the present example embodiment augments the training data by detecting a characteristic portion contributing to the classification of the training data into category and processing the training data in relation to the detected characteristic portion.

(Configuration)

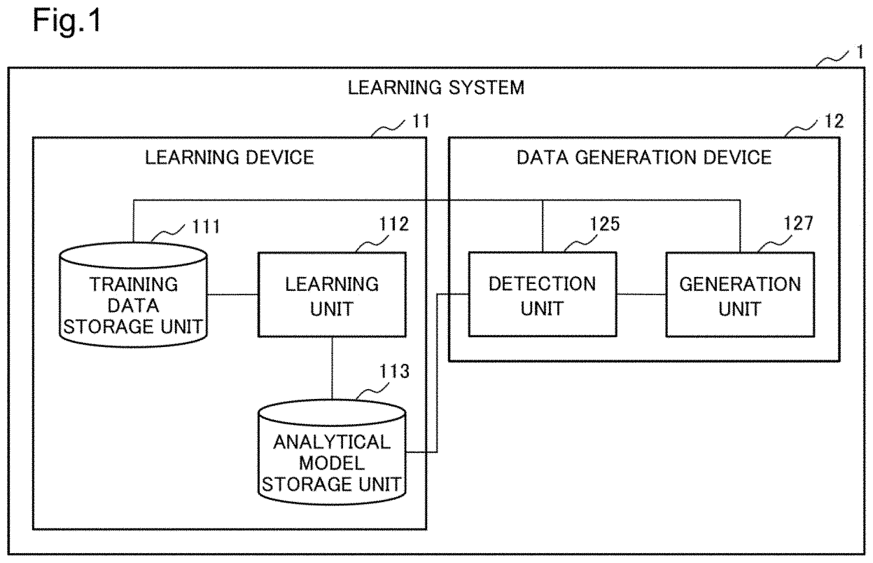

A configuration of the learning system according to the present example embodiment will be described with reference to the drawing. FIG. 1 is a block diagram illustrating an example of a configuration of a learning system 1 of the present example embodiment. The learning system 1 includes a learning device 11 and a data generation device 12. For example, the data generation device 12 can be used as an attachment of the learning device 11.

As illustrated in FIG. 1, the learning device 11 includes a training data storage unit 111, a learning unit 112, and an analytical model storage unit 113. The data generation device 12 includes a detection unit 125 and a generation unit 127.

[Learning Device]

The training data storage unit 111 stores training data (hereinafter, also referred to as first training data) in advance. For example, various types of data are stored in the training data storage unit 111 in association with categories into which the pieces of data are to be classified. Examples of a type of data include image data, text data, various types of time-series data, or the like. However, the type of data is not particularly limited in the present example embodiment, and other types of data may be used. The detection unit 125 may use data other than the training data stored in the training data storage unit 111 as the first training data.

The training data storage unit 111 stores training data (also referred to as second training data) generated by the generation unit 127 as well as the first training data. In addition to the training data storage unit 111, a storage unit (also referred to as an augmented training data storage unit) in which the training data generated by the generation unit 127 is stored may be provided in at least any of the learning device 11 or the data generation device 12. The training data (second training data) generated by the generation unit 127 and stored in the training data storage unit 111 may be used for further augmentation of the training data. In the following description, the first training data and the second training data are simply referred to as training data when not distinguished from each other.

The learning system 1 may use training data acquired from an external system (not illustrated). In this case, the learning system 1 may be configured without the training data storage unit 111.

The learning unit 112 executes learning using the training data acquired from the training data storage unit 111. The learning unit 112 stores a trained analytical model generated by the learning in the analytical model storage unit 113.

In the present example embodiment, the learning unit 112 generates, for example, a neural network (NN) as the analytical model. The NN is, for example, a convolutional neural network (CNN) or a recurrent neural network (RNN). However, a machine learning technique used by the learning unit 112 is not particularly limited as long as being a supervised learning technique capable of detecting (that is, calculation of a degree of attention) a characteristic portion to be described later.

The analytical model storage unit 113 stores the analytical model generated by the learning unit 112. The analytical model stored in the analytical model storage unit 113 may be appropriately used in the detection unit 125 to be described later.

[Data Generation Device]

When the first training data is classified into a prescribed category by the analytical model generated by the learning unit 112, the detection unit 125 detects a characteristic portion contributing to the classification into the prescribed category.

For example, in a case where the training data is image data, the detection unit 125 detects a pixel or an area contributing to the classification into the category as the characteristic portion. In a case where the training data is text data, the detection unit 125 detects a word, an idiom, a phrase, or the like contributing to the classification into the category as the characteristic portion. In a case where the training data is data of a time-series signal, such as a sound wave, the detection unit 125 detects a waveform in a time domain contributing to the classification into the category as the characteristic portion.

The detection unit 125 acquires training data from the training data storage unit 111 and classifies the training data into a category using the analytical model stored in the analytical model storage unit 113. The detection unit 125 detects a characteristic portion contributing to the category classification of the training data. As an example, the detection unit 125 may detect a characteristic portion for training data classified into a correct category, that is, a category associated with data included in the training data.

In a case where the analytical model is a model based on the CNN, the detection unit 125 detects a characteristic portion and visualizes the characteristic portion using a technique of a class activation map (CAM) system, for example, a characteristic portion visualization technique called Grad-CAM. In the case of the RNN, the detection unit 125 detects a characteristic portion and visualizes the characteristic portion using a characteristic portion visualization technique called attention. These visualization techniques will be described in a second example embodiment. The technique by which the detection unit 125 detects a characteristic portion using the analytical model of the NN is not limited to Grad-CAM or attention.

The generation unit 127 generates the second training data by processing the first training data in relation to the characteristic portion detected by the detection unit 125 for the first training data. For example, the generation unit 127 processes the data so as to leave a characteristic of data included in the characteristic portion. The generation unit 127 stores the generated second training data in the training data storage unit 111. The generation unit 127 may generate the second training data using the first training data classified into the correct category.

For example, in a case where the first training data is image data, the generation unit 127 generates the second training data by performing image processing on the first training data into image data in relation to the characteristic portion. For example, in a case where the first training data is text data, the generation unit 127 generates the second training data by replacing a word, an idiom, a phrase, or the like in the text data for the first training data in relation to a characteristic portion. For example, in a case where the first training data is time-series data including signal data, the generation unit 127 generates the second training data by replacing or processing a waveform of the time-series data while leaving a waveform related to the characteristic portion for the first training data.

(Operations)

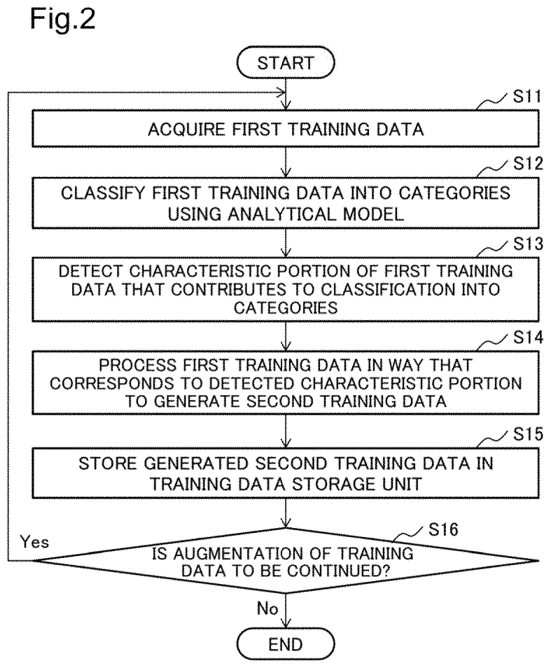

Next, exemplary operations related to data generation processing in which the data generation device 12 of the learning system 1 of the present example embodiment generates the second training data will be described with reference to the drawing. FIG. 2 is a flowchart for describing the exemplary operations of the learning system 1.

In FIG. 2, first, the detection unit 125 acquires the first training data stored in the training data storage unit 111 (step S11).

Next, the detection unit 125 classifies the first training data into a category using the analytical model stored in the analytical model storage unit 113 (step S12).

In step S12, when the first training data is classified into a category using the analytical model, the detection unit 125 detects, from the first training data, a characteristic portion contributing to the classification into the category (step S13).

Next, the generation unit 127 processes the first training data in relation to the detected characteristic portion, thereby generating the second training data (step S14).

Next, the generation unit 127 stores the generated second training data in the training data storage unit 111 (step S15). The generation unit 127 may store the generated second training data in the analytical model storage unit 113.

When augmentation of the training data is continued (Yes in step S16), the processing returns to step S11. On the other hand, when the augmentation of the training data is not continued (No in step S16, the processing according to the flowchart of FIG. 2 is ended. A condition as to whether to continue the augmentation of the training data may be appropriately defined, for example, generation of a desired number of pieces of the second training data or execution of the processing on all pieces of the first training data.

As described above, the generation unit generates the second training data by processing the first training data in relation to the characteristic portion detected by the detection unit in the data generation device of the present example embodiment. The characteristic portion is a portion that contributes to the classification of the first training data into the prescribed category. That is, the data generation device of the present example embodiment generates the second training data including the characteristic portion contributing to the category classification of the first training data.

Then, the second training data generated as described above can be used for learning of the analytical model in the learning device of the present example embodiment. Thus, after relearning, it is possible to learn the analytical model that has mainly learned the characteristic portion contributing to the category classification of the first training data. Therefore, the learning device of the present example embodiment can generate a learning model obtained by performing learning while appropriately paying attention to a part to which attention needs to be paid, and can contribute to improvement of generalization performance. That is, the learning system of the present example embodiment enables generation of the analytical model exhibiting high generalization performance.

### Second Example Embodiment

A learning system according to the second example embodiment of the present invention will be described with reference to the drawings. The learning system of the present example embodiment is an example of augmenting training data to be used for an analytical model using a neural network (hereinafter, also referred to as NN). In the present example embodiment, an example in which training data as a learning target is image data, and a characteristic portion is detected based on a value for each pixel constituting the image data will be described. A technique of the present example embodiment can also be applied to a case where not only the image data but also time-series data, text data, or the like is set as the learning target.

(Configuration)

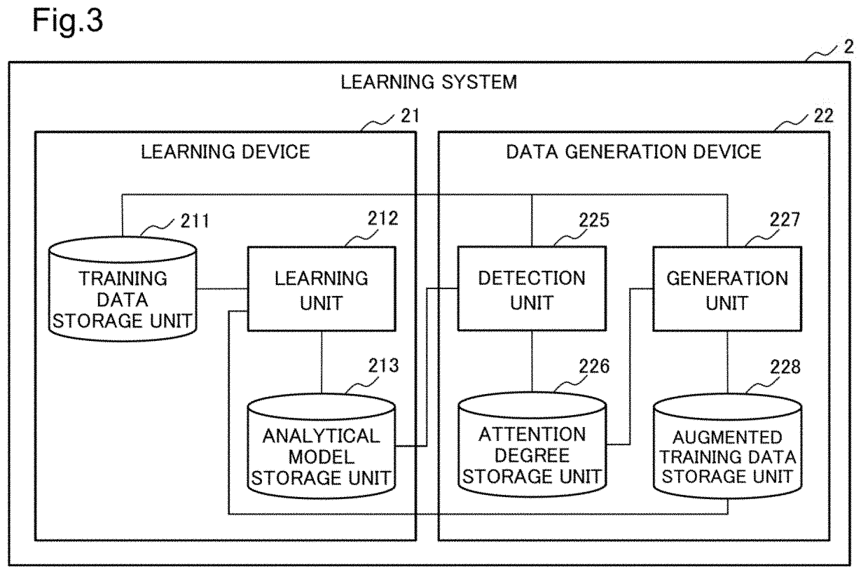

A configuration of the learning system according to the present example embodiment will be described with reference to the drawing. FIG. 3 is a block diagram illustrating an example of a configuration of a learning system 2 of the present example embodiment. The learning system 2 includes a learning device 21 and a data generation device 22.

As illustrated in FIG. 3, the learning device 21 includes a training data storage unit 211, a learning unit 212, and an analytical model storage unit 213. The learning device 21 has a configuration similar to that of the learning device 11 of the first example embodiment. The training data storage unit 211, the learning unit 212, and the analytical model storage unit 213 respectively correspond to the training data storage unit 111, the learning unit 112, and the analytical model storage unit 113 included in the learning device 11. In the following description, detailed descriptions of elements similar to constituent elements described in the first example embodiment are omitted.

The data generation device 22 includes a detection unit 225, an attention degree storage unit 226, a generation unit 227, and an augmented training data storage unit 228.

[Detection Unit]

When first training data is classified into a prescribed category by a trained analytical model, the detection unit 225 detects a characteristic portion contributing to the classification into the prescribed category. Specifically, the detection unit 225 acquires training data from the training data storage unit 211, and classifies the training data into a category using the analytical model stored in the analytical model storage unit 213. The detection unit 225 detects the characteristic portion contributing to the category classification of the training data. More specifically, the detection unit 225 calculates a degree of attention indicating a degree of contribution to the classification into the category for an explanatory variable of the first training data. For example, in a case where the training data is an image, the detection unit 225 calculates the degree of contribution to firing of neurons in an NN as the degree of attention for each pixel constituting the training data. The detection unit 225 may output the calculated degree of attention to the generation unit 227.

In a case where the analytical model is a neural network such as a CNN, the detection unit 225 detects a characteristic portion contributing to classification into a category by using, for example, a technique of a class activation map (CAM) system disclosed in the following NPLs 1 and 2, and calculates the degree of attention.
NPL 1: R. Selvaraju, et al., “Grad-CAM: Visual Explanations from Deep Networks via Gradient-based Localization”, arXiv:1610.02391v3 [cs.CV] 21 Mar. 2017.
NPL 2: D. Smilkov, et al., “SmoothGrad: removing noise by adding noise”, arXiv:1706.03825v1 [cs.LG] 12 Jun. 2017.
NPL 1 discloses a technique called Grad-CAM, and NPL 2 discloses a technique called SmoothGrad.

For example, in the case where the analytical model is the convolutional neural network (CNN), the detection unit 225 calculates the degree of attention using Grad-CAM and maps the degree of attention to the entire training data. In Grad-CAM, a part, which has a large influence on a probability score for each predicted category of classification, is specified by calculating an average of differential coefficients. The differential coefficient is a coefficient representing the magnitude of change that occurs in the probability score when a minute change is applied to a certain part of the training data in a characteristic amount map (attention degree map). The probability score is a probability that a label (tag) for each category is given to training data. Regarding the probability score, for example, in a case where image data of training data includes a cat and a dog, a probability score of the cat is 80%, and a probability score of the dog is 20%, a determination result by the classification is the cat.

In the technique of the CAM, an activation map in which a degree of contribution of the characteristic portion to the category classification is relatively mapped with respect to the entire input is generated outside the neural network. In the general CAM technique, the degree of attention is obtained for each category. On the other hand, the degree of attention for a correct category of each training data is mainly used in the present example embodiment.

As another example of the case where the analytical model is the neural network, the detection unit 225 detects a characteristic portion contributing to classification into a correct category using a technique of an attention system disclosed in the following NPL 3 or 4, and calculates the degree of attention.
NPL 3: F. Wang, et al., “Residual Attention Network for Image Classification”, arXiv:1704.06904v1 [cs.CV] 23 Apr. 2017.
NPL 4: J. Hu, et al., “Squeeze-and-Excitation Networks”, arXiv: 1709.01507v4 [cs.CV] 16 May 2019.
NPL 3 discloses a technique called Residual Attention Network, and NPL 4 discloses a technique called Squeeze-and-Excitation Networks.

In the technique of the attention system, a layer equivalent to the activation map is incorporated inside the neural network. Since the layer equivalent to the activation map is incorporated into a model in the technique of the attention system, self-learning of the degree of a characteristic portion contributing to the category classification is performed at the time of learning.

The techniques described in the above NPLs 1 to 4 are examples for obtaining the degree of attention. The detection unit 225 may use a technique different from the techniques described in these literatures in order to obtain the degree of attention according to a type of the analytical model or the like.

Then, the detection unit 225 detects, as the characteristic portion, a range in which the degree of attention satisfies a prescribed criterion for an explanatory variable of the first training data. A portion in which the degree of attention satisfies the prescribed criterion can be said to be a portion to which attention has been paid by the analytical model when the first training data is classified into a prescribed category by the analytical model. The prescribed criterion may be appropriately defined according to a method for calculating the degree of attention, a type of training data, a classification target, or the like.

The detection unit 225 may detect a characteristic portion contributing to category classification of first training data for the first training data that has been classified into a correct category by the analytical model. In this case, second training data is generated based on the first training data appropriately classified by the analytical model, and thus, the quality of the second training data thus generated can be improved.

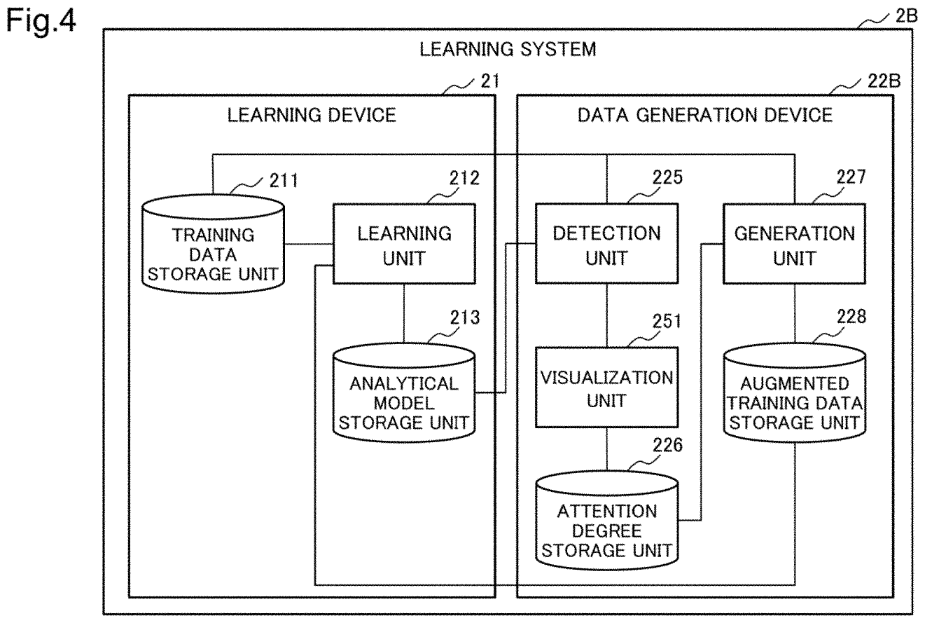

As illustrated in FIG. 4, a learning system 2A, provided with a data generation device 22A in which a visualization unit 251 is added to the data generation device 22, may be configured. The visualization unit 251 generates an attention degree map in which the degree of attention obtained by the detection unit 225 is mapped to the first training data. The attention degree map is a map that visually indicates the degree of attention obtained by the detection unit 225 by superimposing the degree of attention on the training data.

In a case where sample data of the first training data is image data, the visualization unit 251 calculates a degree of attention related to a pixel, which is included in the image data and has contributed to classification, and generates an attention degree map in which the degree of attention is mapped to the entire input image. As another example, in a case where the first training data is text data, the visualization unit 251 calculates a degree of attention regarding a word, an idiom, and a phrase, which is included in the text data and has contributed to classification, and generates an attention degree map in which the degree of attention is mapped to the entire text data. As still another example, in a case where the first training data is data of a time-series signal, the visualization unit 251 calculates a degree of attention in a time domain, which is included in the data of the time-series signal and has contributed to classification, and generates an attention degree map in which the degree of attention is mapped to the entire data of the time-series signal. The visualization unit 251 stores the attention degree map in the attention degree storage unit 226 in association with the training data used to calculate the degree of attention.

The attention degree storage unit 226 stores the degree of attention obtained by the detection unit 225 at the time of detecting the characteristic portion. The attention degree storage unit 226 may store the attention degree map generated by the visualization unit 251.

[Generation Unit]

Next, the generation unit 227 provided in the learning system 2 will be described. The generation unit 227 generates the second training data by processing the first training data in relation to the characteristic portion of the first training data detected based on the degree of attention. As an example, the generation unit 227 processes the data so as to leave a characteristic of data included in the characteristic portion, thereby generating the second training data.

The augmented training data storage unit 228 stores the second training data generated by the generation unit 227. The second training data stored in the augmented training data storage unit 228 is acquired by the learning unit 212. The augmented training data storage unit 228 may be omitted, and the second training data generated by the generation unit 227 may be stored in the training data storage unit 211.

Hereinafter, a specific example of a method for generating the second training data by the generation unit 227 will be described. In the following description, a portion including a characteristic portion in training data is referred to as a first portion, and a portion including a portion other than the characteristic portion is referred to as a second portion.

The generation unit 227 processes the second portion to generate the second training data. In a case where data is an image and category classification is performed on a rigid body such as an industrial product appearing in the image, an external appearance of the rigid body is substantially similar in any image, and a background thereof is likely to change depending on a capturing environment of the image or the like. In this manner, the generation unit 227 generates the second training data by processing the second portion mainly in a case where a characteristic included in a characteristic portion does not change in pieces of training data. Accordingly, it is possible to create the second training data that contributes to generation of the analytical model robust to the change of the second portion corresponding to the background of the image.

In a case where data is an image and a rigid body such as an industrial product appearing in the image is set as a target of classification of normality or abnormality of the industrial product, it is preferable that an external appearance of the product appearing in the image be maintained without any change from the original image even in the generated second training data. Even in such a case, the generation unit 227 processes the second portion to generate the second training data. Accordingly, the generation unit 227 can generate the second training data while avoiding disadvantageous processing.

As another example, the generation unit 227 processes the first portion to generate the second training data. For example, in a case where data is an image and animals appearing in the image are classified into categories with types of the animal as the categories, colors, patterns, shapes, and the like of the animals are different for each individual. That is, a case where it is desired to classify animals having different colors, patterns, shapes, and the like as those belonging to the same category is assumed. In this manner, the generation unit 227 generates the second training data by processing the first portion mainly in a case where characteristics appearing in characteristic portions of pieces of training data are different for each piece of the data. Accordingly, it is possible to create the second training data that contributes to generation of the analytical model robust to the change of the characteristic portion in the training data.

Even in a case where the change of the second portion is insufficient, the generation unit 227 may generate the second training data by processing the first portion. As a result, the second training data is generated for the second portion while avoiding unnecessary processing.

In the case where the generation unit 227 generates the second training data by processing the first portion, it is preferable that the generation unit 227 generate the second training data in which a characteristic that is included in a characteristic portion and has contributed to category classification is retained. For example, in a case where animals appearing in an image are classified into categories with types of the animals as the categories, it is preferable that characteristics of the first training data that have contributed to the classification into the categories, such as faces of the animal, remain in order for appropriate classification by the analytical model. Therefore, it is preferable that the generation unit 227 generate the second training data by performing processing such that the characteristic in the first portion contributing to the category classification is retained at the time of processing the first portion.

[Expanded Training Data]

Here, assuming a case where the training data is an image, the second training data generated by the generation unit 227 will be described with reference to the drawings.

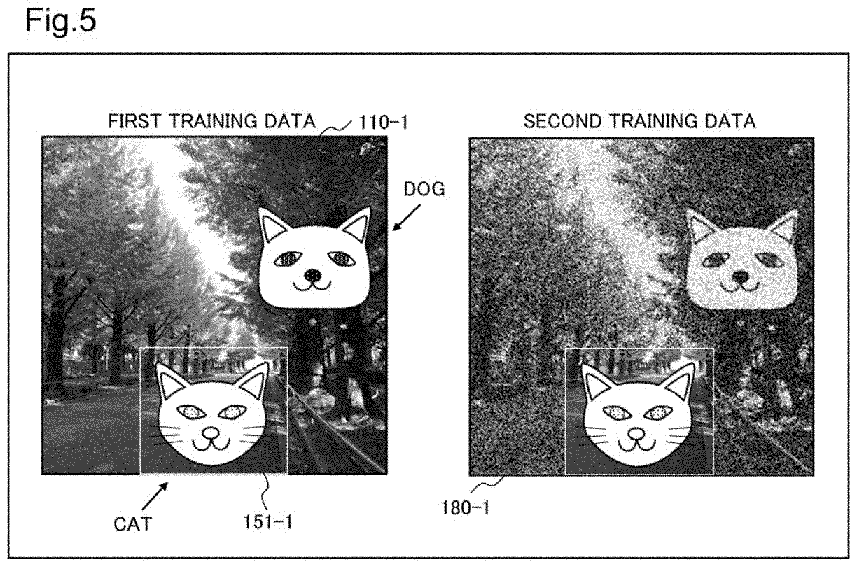

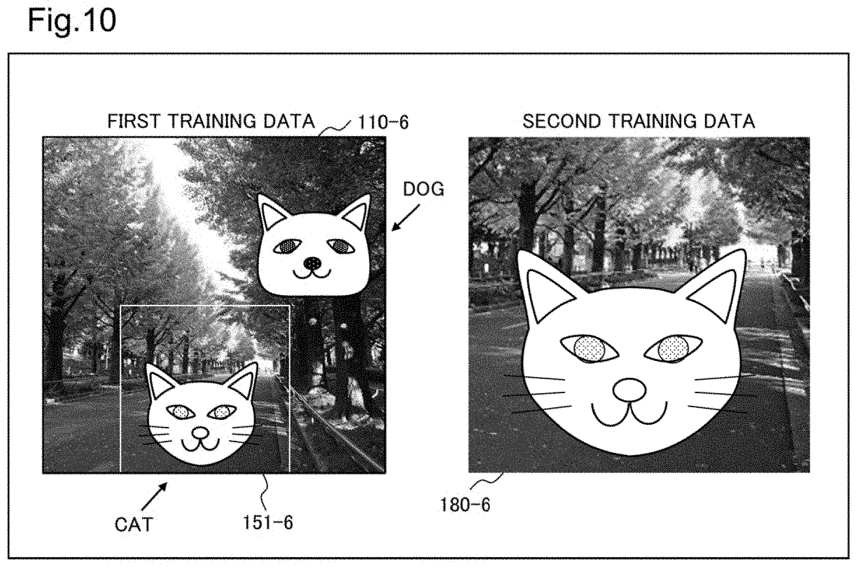

FIGS. 5 to 10 are images for describing the second training data generated by the generation unit 227. FIGS. 5 to 10 are examples in which a cat is set as a target of attention (correct category). In the examples of FIGS. 5 to 10, image data (left side) corresponding to the first training data and image data (right side) of the second training data generated using the first training data are illustrated side by side. In each of FIGS. 5 to 8, a reference of a boundary between the first portion and the second portion is illustrated by a white line (white solid line) for ease of understanding, but an actual image does not include a frame of the white line. Normally, it is preferable that the boundary between the first portion and the second portion not be clear in order to avoid appearance of an unnecessary characteristic in the second training data. Since FIG. 10 is an example in which an image in a first data range is enlarged and used as the image data (right side) of the second training data, the boundary between the first portion and the second portion is not illustrated. FIGS. 5 to 10 illustrate an example in which a technique of the present example embodiment is applied to a black-and-white image, but the technique of the present example embodiment can also be applied to a color image.

FIG. 5 illustrates an example in which the generation unit 227 generates an image 180-1 (right) of the second training data from an image 110-1 (left) of the first training data by noising. For example, as the noising, the generation unit 227 adds noise on the second portion while avoiding a first portion 151-1 including the target of attention (cat) in the category classification, or adds noise on the first portion 151-1. FIG. 5 illustrates an example in which the noising has been performed on the image 110-1 of the first training data while avoiding the first portion 151-1.

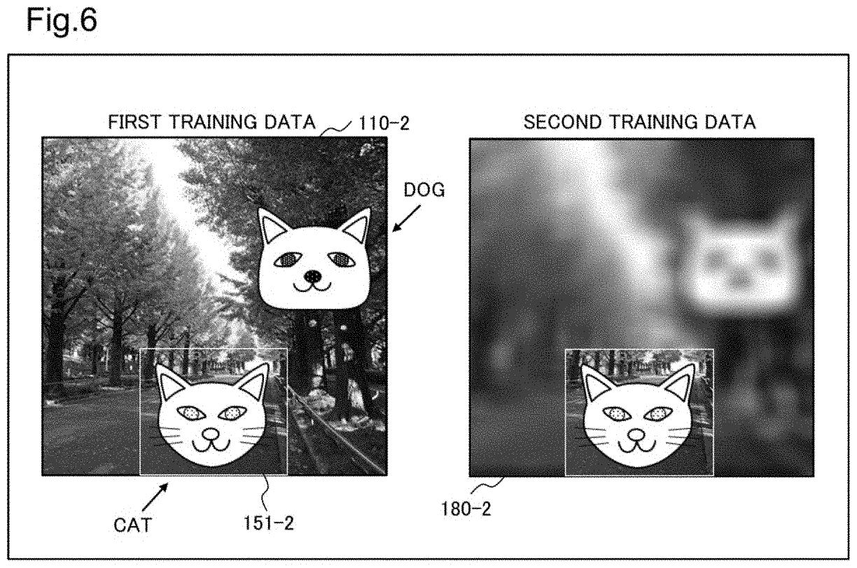

FIG. 6 illustrates an example in which the generation unit 227 generates an image 180-2 (right) of the second training data from an image 110-2 (left) of the first training data by blur. For example, as the blur, the generation unit 227 blurs the second portion while avoiding a first portion 151-2 including the target of attention (cat) in the category classification or blurs the first portion 151-2. FIG. 6 illustrates an example in which the blur has been performed on the image 110-2 of the first training data for the second portion while avoiding the first portion 151-2.

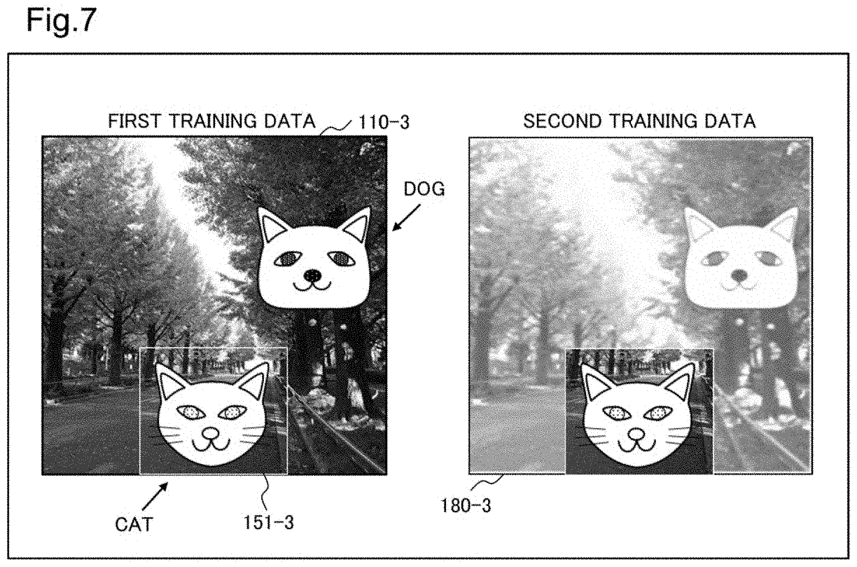

FIG. 7 illustrates an example in which the generation unit 227 generates an image 180-3 (right) of the second training data from an image 110-3 (left) of the first training data by coloring. Although the coloring is performed on a color image, FIG. 7 illustrates a black-and-white image. For example, as the coloring, the generation unit 227 performs coloring for the second portion while avoiding a first portion 151-3 including the target of attention (cat), or performs coloring on the first portion 151-3. FIG. 7 illustrates an example in which the coloring has been performed on the image 110-3 of the first training data for the second portion while avoiding the first portion 151-3.

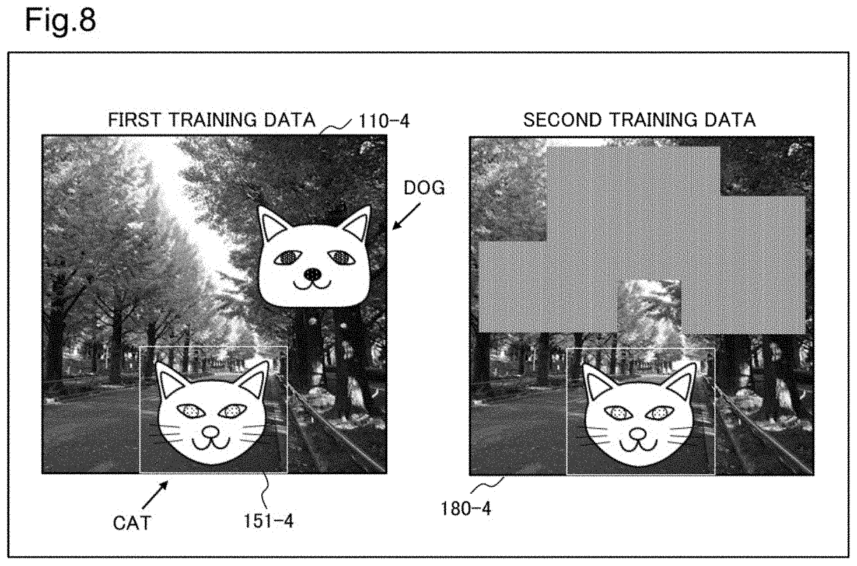

FIG. 8 illustrates an example in which the generation unit 227 generates an image 180-4 (right) of the second training data from an image 110-4 (left) of the first training data by cutout/random erasing. For example, as the cutout/random erasing, the generation unit 227 masks the second portion while avoiding a first portion 151-4 including the target of attention (cat) in the category classification. FIG. 8 illustrates an example in which the cutout/random erasing has been performed on the image 110-4 of the first training data for the second portion while avoiding the first portion 151-4.

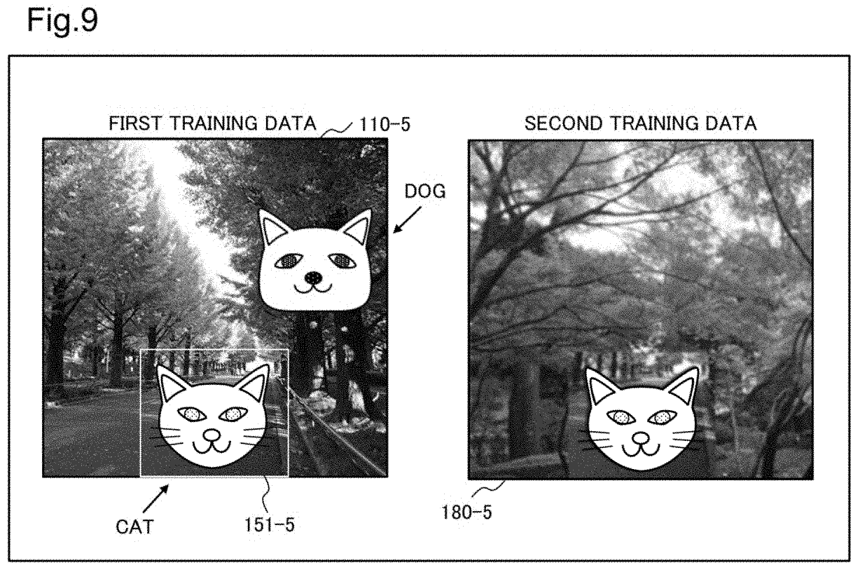

FIG. 9 illustrates an example in which the generation unit 227 generates an image 180-5 (right) of the second training data from an image 110-5 (left) of the first training data by mixup. For example, as the mixup, the generation unit 227 mixes a first portion 151-5 including the target of attention (cat) with a freely selected image by replacing an area not including the target of attention (cat) in the category classification with the freely selected image. Contrast in colors, tones, or the like is more noticeable at a boundary of the first portion 151-5 as compared with other areas. Thus, it is better to make the boundary of the first portion 151-5 inconspicuous by gradations or the like.

FIG. 10 illustrates an example in which the generation unit 227 generates an image 110-6 (right) of the second training data using an image 180-6 (left) of the first training data by crop. For example, the generation unit 227 cuts out a first portion 151-6 including the target of attention (cat) as the crop. FIG. 10 illustrates an example in which the crop of cutting out and enlarging the first portion 151-6 of the image 110-6 of the first training data has been performed.

The technique used by the generation unit 227 at the time of generating the second training data is not limited to the above examples. In a case where the training data is an image, the generation unit 227 may generate the second training data using conversion such as rotation, shift, shear, flip, or zoom. In a case where the training data is text data, the generation unit 227 generates the second training data by replacing a word, an idiom, or a phrase included in a portion to be processed with another word, idiom, or phrase for the training data. In a case where the training data is data of a time-series signal, the training data generation unit 273 generates the second training data by appropriately replacing or changing a waveform included in a portion to be processed.

In the case where the generation unit 227 processes the second portion to generate the second training data by processing the second portion, the generation unit 227 can normally use any processing described above.

On the other hand, in the case where the generation unit 227 generates the second training data by processing the first portion, it is preferable that the generation unit 227 generate the second training data in which the characteristic in the first portion contributing to the category classification is retained as described above. Thus, it is preferable that the generation unit 227 generate the second training data using processing that leaves the characteristic included in the first portion in the case of processing the first portion. Therefore, when the training data is an image in this case, it is preferable that the generation unit 227 generate the second training data by processing that enables retaining of the characteristic included in the first portion, such as the noising, the coloring, the rotation, the flip, the zoom, or the crop.

As described above, in one aspect of the present example embodiment, when the first training data is classified into the prescribed category by the trained analytical model, the detection unit detects the characteristic portion that contributes to the classification into the prescribed category. For example, the detection unit calculates the degree of attention indicating the degree of contribution to the classification of the first training data into the prescribed category, and detects a portion where the degree of attention is larger than a prescribed index as the characteristic portion. For example, the detection unit detects the characteristic portion from the first training data using at least any technique of the class activation map (CAM) system or the attention system.

In the present aspect, the characteristic portion is detected based on the degree of attention indicating the degree of contribution to the category classification of the first training data. Thus, a large amount of training data including the characteristic portion contributing to the category classification is generated according to the present example embodiment, and this makes it possible to construct the analytical model exhibiting higher generalization performance.

In one aspect of the present example embodiment, before calculating the degree of attention, the detection unit detects the characteristic portion for the first training data correctly classified into the correct category, that is, the category associated with the training data. Then, the generation unit generates the second training data using the first training data classified into the correct category. As a result, it is possible to generate the training data that enables the construction of the analytical model exhibiting higher generalization performance according to the present aspect.

In one aspect of the present example embodiment, the generation unit generates the second training data by processing either the first portion including the characteristic portion in the first training data or the second portion including a portion other than the characteristic portion. As a result, it is possible to generate the training data in accordance with a target of the category classification target or use.

In general, the generalization performance of the analytical model is likely to be improved by increasing the number of pieces of training data by data augmentation, but learning takes time in some cases. According to the present example embodiment, however, the data augmentation effective for the improvement of generalization performance can be performed, and thus, the possibility that relatively high generalization performance can be obtained increases even when an increased number of pieces of data is small.

In the general data augmentation, there is a possibility that training data that should not be learned is generated because the data augmentation is performed by random processing. In the present example embodiment, the data augmentation is performed based on the degree of attention indicating the degree of contribution of the characteristic portion to the category classification of the training data. Thus, it is possible to prevent generation of disadvantageous training data that should not be learned, such as masking of the characteristic portion to which attention needs to be paid, according to the present example embodiment. That is, the data augmentation effective for the improvement of generalization performance can be performed according to the present example embodiment, and as a result, the possibility that the relatively high generalization performance can be obtained increases even when the increased number of pieces of data is small.

In a case where an area to which attention needs to be paid is extracted by general image processing when training data is an image, a degree of attention according to a trained analytical model is not considered. Thus, there is a possibility that a discrepancy occurs between a characteristic portion acquired by the analytical model by pre-learning and an area to which attention needs to be paid, the area being specified in the image processing. On the other hand, in the present to example embodiment, the data augmentation is performed in consideration of an attention point of the trained analytical model, and thus, the possibility of occurrence of the discrepancy described above decreases.

The technique of the present example embodiment can also be applied to an application for augmenting training data to be used for learning of data other than the image data.

For example, the technique of the present example embodiment can also be applied to an application for augmenting training data to be used for learning of time-series data such as sensor data and voice data. In a case where the technique of the present example embodiment is applied to the augmentation of training data to be used for learning of the time-series data, for example, a waveform, a value, or the like contributing to category classification is detected from the training data as a characteristic portion. Then, as an example, the training data is augmented by replacing data of a portion other than the characteristic portion. When the data is to be replaced, it is preferable to perform processing such as smoothing or data interpolation such that a boundary with the characteristic portion is not clear.

For example, the technique of the present example embodiment can also be applied to an application for augmenting training data to be used for learning of text data. In a case where the technique of the present example embodiment is applied to the augmentation of training data to be used for learning of the text data, for example, a word, an idiom, a phrase, or the like that contributes to category classification is detected from the training data as a characteristic portion. Then, as an example, the to training data can be augmented by replacing a word, an idiom, a phrase, or the like included in a portion other than the characteristic portion. For example, when a word is to be replaced, it is preferable to replace the same part of speech or the same unit, such as to replace a noun with a noun, to replace a verb with a verb, or to replace a phrase with another phrase. For example, it is more preferable to perform analysis by morphological analysis, syntax analysis, semantic analysis, context analysis, or the like such that replaced text becomes natural.

Although the case where the analytical model is the neural network has been mainly described in each of the above example embodiments, the technique described in each of the above example embodiments can be applied to supervised learning other than the neural network in which a degree of attention can be defined.

### Third Example Embodiment

Next, a data generation device according to a third example embodiment of the present invention will be described with reference to the drawing. The data generation device of the present example embodiment increases the number of pieces of training data as learning targets by using training data to be used for learning.

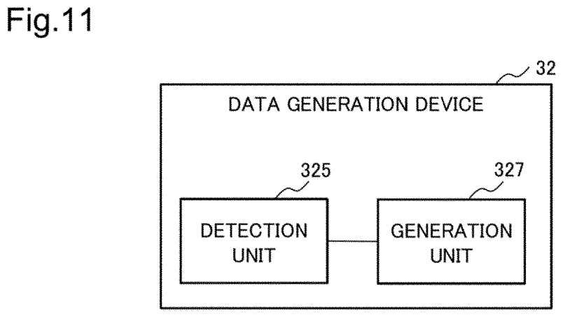

FIG. 11 is a block diagram illustrating an example of a configuration of the data generation device according to the present example embodiment. As illustrated in FIG. 11, a data generation device 32 includes a detection unit 325 and a generation unit 327.

When first training data is classified into a prescribed category by a trained analytical model, the detection unit 325 detects a characteristic portion contributing to the classification into the prescribed category from the first training data.

The generation unit 327 generates second training data by processing the first training data in relation to the characteristic portion.

The data generation device according to the present example embodiment generates training data capable of generating an analytical model for which learning has been performed by appropriately paying attention to a part to which attention needs to be paid, and thus, can contribute to improvement of generalization performance. That is, it is possible to generate the training data that enables the generation of the analytical model exhibiting high generalization performance according to the data generation device of the present example embodiment.

(Hardware Configuration)

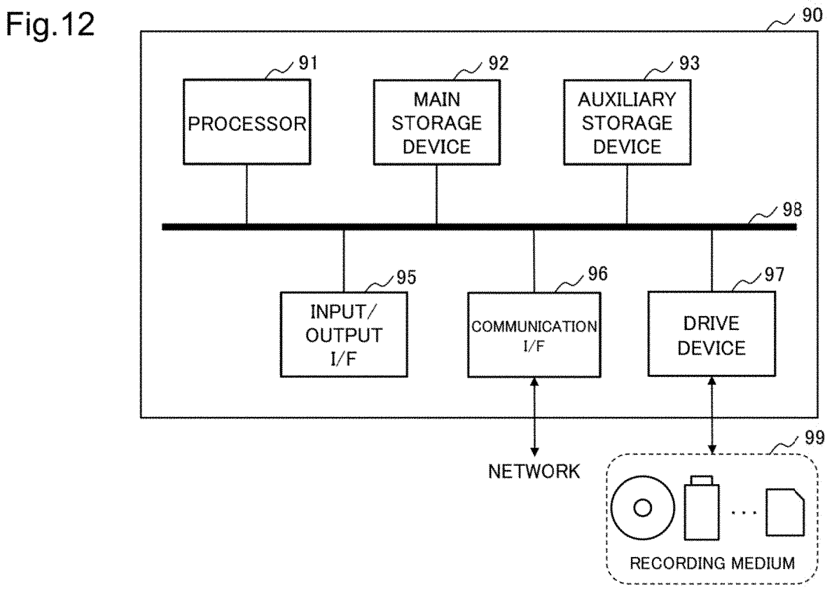

Here, a hardware configuration for implementing the learning system (including the data generation device according to the third example embodiment) according to each of the example embodiments of the present invention will be described with an information processing device 90 in FIG. 12 as an example.

As illustrated in FIG. 12, the information processing device 90 includes a processor 91, a main storage device 92, an auxiliary storage device 93, an input/output interface 95, a communication interface 96, and a drive device 97. In FIG. 12, the interface is abbreviated as an I/F (interface). The processor 91, the main storage device 92, the auxiliary storage device 93, the input/output interface 95, the communication interface 96, and the drive device 97 are connected to each other via a bus 98 such that data communication is possible. The processor 91, the main storage device 92, the auxiliary storage device 93, and the input/output interface 95 are connected to a network, such as the Internet or an intranet, via the communication interface 96. FIG. 12 illustrates a recording medium 99 capable of recording data.

The processor 91 develops a program stored in the auxiliary storage device 93 or the like in the main storage device 92 and executes the developed program. In the present example embodiment, a software program installed in the information processing device 90 may be used. The processor 91 executes processing by the learning system according to each of the example embodiments.

The main storage device 92 has an area in which the program is to be developed. The main storage device 92 is configured using, for example, a volatile memory such as a dynamic random access memory (DRAM).

The auxiliary storage device 93 stores various types of data. The auxiliary storage device 93 is configured using a local disk such as a hard disk or a flash memory.

The input/output interface 95 is an interface configured to connect the information processing device 90 and peripheral devices. The communication interface 96 is an interface configured for connection to an external system or device through a network, such as the Internet or an intranet, in accordance with a standard or a specification. The input/output interface 95 and the communication interface 96 may be configured as a common interface for connection to external devices.

The information processing device 90 may be configured to allow connection of input devices such as a keyboard, a mouse, and a touch panel as necessary. These input devices are used to input information and settings. When the touch panel is used as the input device, a display screen of a display device may also serve as an interface of the input device. Data communication between the processor 91 and the input device may be relayed by the input/output interface 95.

The information processing device 90 may be provided with a display device configured to display information. In a case where the display device is provided, it is preferable that the information processing device 90 be provided with a display control device (not illustrated) configured to control display of the display device. The display device may be connected to the information processing device 90 via the input/output interface 95.

The drive device 97 is connected to the bus 98. The drive device 97 relays reading of data and a program from the recording medium 99, writing of a processing result of the information processing device 90 into the recording medium 99, and the like between the processor 91 and the recording medium 99 (program recording medium). The drive device 97 may be omitted in a case where the recording medium 99 is not used.

The recording medium 99 can be implemented by, for example, an optical recording medium such as a compact disc (CD) or a digital versatile disc (DVD). The recording medium 99 may be implemented by a semiconductor recording medium such as a universal serial bus (USB) memory or a secure digital (SD) card, a magnetic recording medium such as a flexible disk, or other recording media. In a case where the program to be executed by the processor is recorded in the recording medium 99, the recording medium 99 corresponds to a program recording medium.

The hardware configuration of FIG. 12 is an example of a hardware configuration for executing arithmetic processing of the learning system according to each of the example embodiments, and does not limit the scope of the present invention. A program that causes a computer to execute processing related to the learning system according to each of the example embodiments is also included in the scope of the present invention. Further, a program recording medium in which the program according to each of the example embodiments is recorded is also included in the scope of the present invention.

The constituent elements of the learning system of each of the example embodiments can be freely combined. The constituent elements of the learning system of each of the example embodiments may be implemented by software or may be implemented by circuits.

While the invention has been particularly shown and described with reference to exemplary embodiments thereof, the invention is not limited to these embodiments. It will be understood by those of ordinary skill in the art that various changes in form and details may be made therein without departing from the spirit and scope of the present to invention as defined by the claims.

Some or all of the above example embodiments may be described as the following supplementary notes, but are not limited to the following.

(Supplementary Note 1)

A data generation device including:

a detection unit that detects a characteristic portion that contributes to classification into a prescribed category from first training data when the first training data is classified into the prescribed category by a trained analytical model; and

a generation unit that generates second training data by processing the first training data in relation to the characteristic portion.

(Supplementary Note 2)

The data generation device according to Supplementary Note 1, in which

the detection unit detects the characteristic portion for the first training data classified into a correct category.

(Supplementary Note 3)

The data generation device according to Supplementary Note 1 or 2, in which

the generation unit generates the second training data by processing a first portion including a portion other than the characteristic portion of the first training data.

(Supplementary Note 4)

The data generation device according to any one of Supplementary Notes 1 to 3, in which

the generation unit generates the second training data by processing a second portion including the characteristic portion of the first training data.

(Supplementary Note 5)

The data generation device according to Supplementary Note 4, in which

the generation unit generates the second training data by processing the second portion in such a way as to leave a characteristic included in the second portion.

(Supplementary Note 6)

The data generation device according to any one of Supplementary Notes 1 to 5, in which

the first training data and the second training data are image data.

(Supplementary Note 7)

The data generation device according to any one of Supplementary Notes 1 to 5, in which

the first training data and the second training data are text data.

(Supplementary Note 8)

The data generation device according to any one of Supplementary Notes 1 to 5, in which

the first training data and the second training data are time-series signal data.

(Supplementary Note 9)

The data generation device according to any one of Supplementary Notes 1 to 8, in which

the detection unit

calculates a degree of attention for an explanatory variable of the first training data, the degree of attention indicating a degree of contribution to the classification into the prescribed category, and

detects the characteristic portion based on the degree of attention.

(Supplementary Note 10)

The data generation device according to Supplementary Note 9, in which

the detection unit calculates the degree of attention for the first training data using at least one of a class activation map (CAM) method or an attention method.

(Supplementary Note 11)

The data generation device according to Supplementary Note 9 or 10, further including

a visualization unit configured to generate an attention degree map in which the degree of attention is mapped to the first training data.

(Supplementary Note 12)

The data generation device according to Supplementary Note 11, in which

the visualization unit outputs the attention degree map to a display device.

(Supplementary Note 13)

A learning system including:

the data generation device according to any one of Supplementary Notes 1 to 10; and

a learning device that generates a model for classifying the first training data or the second training data into the category by machine learning.

(Supplementary Note 14)

A data generation method, executed by a computer, including:

detecting a characteristic portion that contributes to classification into a prescribed category from first training data when the first training data is classified into the prescribed category by a trained analytical model; and

generating second training data by processing the first training data in relation to the characteristic portion.

(Supplementary Note 15)

A program configured to cause a computer to execute:

a process of detecting a characteristic portion that contributes to classification into a prescribed category from first training data when the first training data is classified into the prescribed category by a trained analytical model; and

a process of generating second training data by processing the first training data in relation to the characteristic portion.

### REFERENCE SIGNS LIST

1, 2 learning system
11, 21 learning device
12, 22 data generation device
111, 211 training data storage unit
112, 212 learning unit
113, 213 analytical model storage unit
125, 225 detection unit
127, 227 generation unit
226 attention degree storage unit
228 augmented training data storage unit
251 visualization unit

What is claimed is:

1. A data generation device comprising:
at least one memory storing instructions; and
at least one processor configured to access the at least one memory and execute the instructions to:
detect a characteristic portion that contributes to classification into a prescribed category from first training data when the first training data is classified into the prescribed category by a trained analytical model; and
generate second training data by processing the first training data in relation to the characteristic portion.

2. The data generation device according to claim 1, wherein
the at least one processor is further configured to execute the instructions to:
detect the characteristic portion for the first training data classified into a correct category.

3. The data generation device according to claim 1, wherein
the at least one processor is further configured to execute the instructions to:
generate the second training data by processing a first portion including a portion other than the characteristic portion of the first training data.

4. The data generation device according to claim 1, wherein
the at least one processor is further configured to execute the instructions to:
generate the second training data by processing a second portion including the characteristic portion of the first training data.

5. The data generation device according to claim 4, wherein
the at least one processor is further configured to execute the instructions to:
generate the second training data by processing the second portion in such a way as to leave a characteristic included in the second portion.

6. The data generation device according to claim 1, wherein
the first training data and the second training data are image data.

7. The data generation device according to claim 1, wherein
the first training data and the second training data are text data.

8. The data generation device according to claim 1, wherein
the first training data and the second training data are time-series signal data.

9. The data generation device according to claim 1, wherein
the at least one processor is further configured to execute the instructions to:
calculate a degree of attention for an explanatory variable of the first training data, the degree of attention indicating a degree of contribution to the classification into the prescribed category; and
detect the characteristic portion based on the degree of attention.

10. The data generation device according to claim 9, wherein
the at least one processor is further configured to execute the instructions to:
calculate the degree of attention for the first training data using at least one of a class activation map (CAM) method or an attention method.

11. The data generation device according to claim 9, wherein
the at least one processor is further configured to execute the instructions to:
generate an attention degree map in which the degree of attention is mapped to the first training data.

12. The data generation device according to claim 11, wherein
the at least one processor is further configured to execute the instructions to:
output the attention degree map to a display device.

13. The data generation device according to claim 1; wherein
the at least one processor is further configured to execute the instructions to:
generate a model for classifying the first training data or the second training data into the category by machine learning.

14. A data generation method, executed by a computer, comprising:
detecting a characteristic portion that contributes to classification into a prescribed category from first training data when the first training data is classified into the prescribed category by a trained analytical model; and
generating second training data by processing the first training data in relation to the characteristic portion.

15. A non-transitory program recording medium storing a program for causing a computer to execute:
a process of detecting a characteristic portion that contributes to classification into a prescribed category from first training data when the first training data is classified into the prescribed category by a trained analytical model; and
a process of generating second training data by processing the first training data in relation to the characteristic portion.
